(19) United States
(12) Patent Application Publication
(10) Pub. No.: US 2019/0180355 A1
(43) Pub. Date: Jun. 13, 2019

(54) MANAGEMENT SYSTEM, MANAGEMENT METHOD, AND NON-TRANSITORY RECORDING MEDIUM

(71) Applicant: Toyota Jidosha Kabushiki Kaisha, Toyota-shi (JP)

(72) Inventors: Koichi Suzuki, Miyoshi-shi Aichi-ken (JP); Katsunori Takami, Tachikawa-shi Tokyo (JP)

(73) Assignee: Toyota Jidosha Kabushiki Kaisha, Toyota-shi Aichi-ken (JP)

(21) Appl. No.: 16/158,737

(22) Filed: Oct. 12, 2018

(30) Foreign Application Priority Data
Dec. 7, 2017 (JP) 2017-235255

(51) Int. Cl. G06Q 30/06; G07B 15/00; G08G 1/14; G06Q 10/02; G06Q 50/10

(52) U.S. Cl. CPC G06Q 30/0645; G07B 15/00; G08G 1/148; G06Q 10/02; G06Q 50/10; G08G 1/149

(57) ABSTRACT

A management system includes a processing device. The processing device is configure to: acquire schedule information indicating an action schedule of a user; specify, from the schedule information, a date and time at which the user is scheduled to use the vehicle and a date and time at which the user is not scheduled to use the vehicle; notify a parking space management system of information indicating the date and time at which the user is scheduled to use the vehicle as information indicating a vacant time at which the parking space is available; and notify a vehicle management system of information indicating the date and time at which the user is not scheduled to use the vehicle as information indicating a vacant time at which the vehicle is available. The user has authority to use a vehicle and authority to use a parking space set to park the vehicle.

### CROSS-REFERENCE TO RELATED APPLICATIONS

This application claims priority to Japanese Patent Application No. 2017-235255 filed on Dec. 7, 2017, incorporated herein by reference in its entirety.

### BACKGROUND

### 1. Technical Field

The present disclosure relates to a management system, a management method, and a non-transitory recording medium.

### 2. Description of Related Art

Car sharing allows members to share a vehicle and to check usage states of the vehicle or make reservations via the Internet in a community limited to a certain area. As a location of renting and returning, a convenient place for members to use is often chosen, such as a parking space near a residence or a place near a station. By the car sharing as described above, a user can reduce expenses such as a purchase cost, a maintenance cost, and a parking fee of a vehicle, compared with a case of owing the vehicle. With the background described above, parking space sharing that shares a parking space is widespread as well as car sharing that shares a vehicle. As a system for managing parking space reservations for parking space sharing, for example, Japanese Unexamined Patent Application Publication No. 2012-215923 (JP 2012-215923 A) discloses a parking space reservation system.

### SUMMARY

Meanwhile, when a vehicle is in use, since a parking space for parking the vehicle is vacant, the cost for maintenance of the vehicle may be covered by renting the parking space to a person who desires to use the parking space in a vacant time available for the parking space.

However, the existing car sharing system for managing a rental schedule of a vehicle and the existing parking space sharing system for managing a rental schedule of a parking space independently manage the rental schedules without cooperating with each other. Consequently, the owner of the vehicle and the parking space needs to register a vacant time available for each of the car sharing system and the parking space sharing system, and the procedure is complicated. It takes considerable cost and time to newly design and develop a system for managing a rental schedule of a vehicle and a rental schedule of a parking space in an integrated manner, apart from the existing car sharing system and the existing parking space sharing system. In addition, the unique system is highly likely to have poor general-purpose properties, thus development investment costs may not be recovered.

The present disclosure provides a management system, a management method, and a non-transitory recording medium capable of managing a rental schedule of a vehicle and a rental schedule of a parking space at a low cost in an integrated manner.

A first aspect of the present disclosure relates to a management system. The management system includes a processing device. The processing device is configured to acquire schedule information indicating an action schedule of a user having authority to use a vehicle and authority to use a parking space set to park the vehicle. The processing device is configured to specify, from the schedule information, a date and time at which the user is scheduled to use the vehicle and a date and time at which the user is not scheduled to use the vehicle. The processing device is configured to notify a parking space management system, which manages rental of the parking space for a user who desires to use the parking space, of information indicating the date and time at which the user is scheduled to use the vehicle as information indicating a vacant time at which the parking space is available. The processing device is configured to notify a vehicle management system, which manages rental of the vehicle for a user who desires to use the vehicle, of information indicating the date and time at which the user is not scheduled to use the vehicle as information indicating a vacant time at which the vehicle is available.

In the management system according to the first aspect of the present disclosure, the processing device may be configured to surmise the date and time at which the user is scheduled to use the vehicle based on a past action history of the user when the processing device determines that the schedule information is not sufficient to specify the date and time at which the user is scheduled to use the vehicle. The processing device may be configured to notify the user to confirm whether or not the surmised date and time is correct.

In the management system according to the first aspect of the present disclosure, the processing device may be configured to surmise a date and time at which the user is not scheduled to use the vehicle based on a past action history of the user when the processing device determines that the schedule information is not sufficient to specify the date and time at which the user is not scheduled to use the vehicle. The processing device may be configured to notify the user to confirm whether or not the surmised date and time is correct.

In the management system according to the first aspect of the present disclosure, the processing device may be configured to surmise that the vehicle is used at a date and time of traveling to a destination registered in the schedule information when the destination is the same as a destination indicating a place where the user went out using the vehicle in the past.

In the management system according to the first aspect of the present disclosure, the processing device may be configured to surmise that transportation means other than the vehicle is used at a date and time of traveling to a destination registered in the schedule information when the destination is the same as a destination indicating a place where the user went out to using the transportation means other than the vehicle in the past.

In the management system according to the first aspect of the present disclosure, the processing device may be configured to notify the user to confirm transportation means when a date and time of traveling is registered in the schedule information but transportation means is not registered.

A second aspect of the present disclosure relates to a management method. The management method includes: acquiring schedule information indicating an action schedule of a user having authority to use a vehicle and authority to use a parking space set to park the vehicle, by a processing device; specifying, from the schedule information, a date and time at which the user is scheduled to use the vehicle and a date and time at which the user is not scheduled to use the vehicle, by the processing device; notifying a parking space management system, which manages rental of the parking space for a user who desires to use the parking space, of information indicating the date and time at which the user is scheduled to use the vehicle as information indicating a vacant time at which the parking space is available, by the processing device; and notifying a vehicle management system, which manages rental of the vehicle for a user who desires to use the vehicle, of information indicating the date and time at which the user is not scheduled to use the vehicle as information indicating a vacant time at which the vehicle is available, by the processing device.

A third aspect of the present disclosure relates to a readable non-transitory recording medium in which a plurality of instructions is recorded. The instructions are executed by one or more processing devices to cause the one or more processing devices to perform the following method, The method includes; acquiring schedule information indicating an action schedule of a user having authority to use a vehicle and authority to use a parking space set to park the vehicle, by a processing device; specifying, from the schedule information, a date and time at which the user is scheduled to use the vehicle and a date and time at which the user is not scheduled to use the vehicle, by the processing device; notifying a parking space management system, which manages rental of the parking space for a user who desires to use the parking space, of information indicating the date and time at which the user is scheduled to use the vehicle as information indicating a vacant time at which the parking space is available, by the processing device; and notifying a vehicle management system, which manages rental of the vehicle for a user who desires to use the vehicle, of information indicating the date and time at which the user is not scheduled to use the vehicle as information indicating a vacant time at which the vehicle is available, by the processing device.

With the management system, the management method, and the non-transitory recording medium according to the aspects of the present disclosure, it is possible to manage a rental schedule of a vehicle and a rental schedule of a parking, space at a low cost in an integrated manner.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an explanatory diagram showing functional blocks of a management system according to an embodiment of the present disclosure.

### DETAILED DESCRIPTION OF EMBODIMENTS

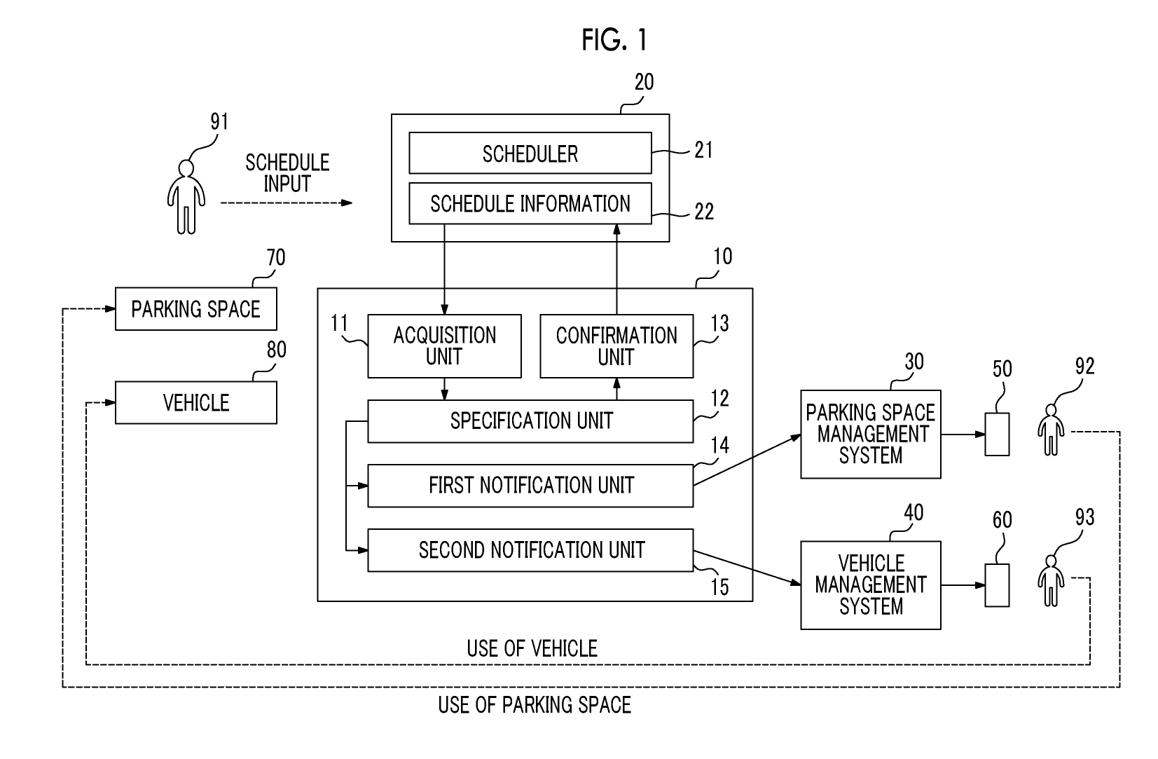

An embodiment of the present disclosure will be described below with reference to the drawing. Here, the same reference numerals are defined to denote the same constituent elements, and thus duplicate descriptions will be omitted. FIG. 1 is an explanatory diagram showing functional blocks of a management system 10 according to the embodiment of the present disclosure. A user 91 has authority to use a vehicle 80 and a parking space 70 together, and the parking space 70 is a space for parking the vehicle 80. The user 91 is not necessarily limited to an owner having an ownership of the parking space 70 and the vehicle 80, but may have authority to use the parking space 70 and the vehicle 80.

The management system 10 is a computer system that executes a management method for managing rental of the parking space 70 and rental of the vehicle 80 in an integrated manner (hereinafter simply referred to as “management system”). The management system 10 includes a processor a storage device, and a communication module as hardware resources. A management program for executing the management method (it can be regarded as a plurality of instructions of the present disclosure) is stored in the storage device. The processor interprets and executes the management program, and functions as various units (an acquisition unit 11, a specification unit 12, a confirmation unit 13, a first notification unit 14, and a second notification unit 15) are implemented. The various units are functions implemented by the cooperation of the hardware resources of the management system 10 and the management program, and details of the functions will be described later. The management program may include, for example, a plurality of software modules which is invoked and executed in a main program, Each of the aforementioned software modules is a subprogram which is modularized for executing processes for implementing the functions of the various units described above. Functions similar to the aforementioned functions of the various units may be implemented by using dedicated hardware resources (for example, application specific integrated circuits) or firmware. The storage device that stores the management program is, for example, a computer readable recording medium such as a semiconductor memory or a disk medium.

An information terminal 20 includes a scheduler 21 that manages schedule information 22 indicating an action schedule of the user 91. The scheduler 21 is an application program (for example, a calendar and schedule management application program) that performs management such as input, change, or deletion of the schedule information 22 through operation of the information terminal 20 perforated by the user 91. A method by which the user 91 inputs the schedule information 22 to the information terminal 20 may be a key input operation to the information terminal 20 or voice input using voice recognition. In a case of the voice input, the schedule information 22 is input to the information terminal 20 through a conversation between the information terminal 20 and the user 91. The schedule information 22 includes, for example, information such as a date and time at which a user is scheduled to go out, a place to which a user is to go, or transportation means. The information on the transportation means includes, for example, information indicating whether or not to use the vehicle 80 (in a case of not using the vehicle 80, the information on the transportation means may include information indicating whether the user goes out by public transportation or on foot). The information terminal 20 may be, for example, a mobile communication terminal having a mobile communication function such as a multifunctional mobile phone called a smartphone or a tablet terminal, or a personal computer having a communication function.

The acquisition unit 11 is connected to the information terminal 20 via a communication line and acquires the schedule information 22 from the scheduler 21. The specification unit 12 specifies, from the schedule information 22, a date and time at which the user 91 is scheduled to use the vehicle 80 and a date and time at which the user 91 is not scheduled to use the vehicle 80. For example, in a case where a schedule that the user 91 will go out using the vehicle 80 from 1;00 pm to 2:00 pm on December 1 is registered in the schedule information 22, the specification unit 12 specifies that the registered date and time (from 1:00 pm to 2:00 pm on December 1) is the date and time at which the user 91 is scheduled to use the vehicle 80. Alternatively, for example in a case where a schedule that the user 91 goes out using a public transportation system (transportation means other than the vehicle 80) from 4:00 pm to 8:00 pm on December 2 is registered in the schedule information 22, the specification unit 12 specifies that the registered date and time (from 4:00 pm to 8:00 pm on December 2) is the date and time at which the user 91 is not scheduled to use the vehicle 80.

When the confirmation unit 13 determines that the schedule information 22 is not sufficient to specify the date and time at which the user 91 is scheduled to use the vehicle 80, the confirmation unit 13 may surmise the date and time at which the user 91 is scheduled to use the vehicle 80 based on a past action history of the user 91. The confirmation unit 13 may notify the user 91 to confirm whether or not the surmised date and time is correct. The past action history of the user 91 can be read from the past schedule information 22. For example, the confirmation unit 13 may surmise that the vehicle 80 is used at the date and time of traveling to a destination registered in the schedule information 22 when the destination is the same as a destination indicating a place where the user 91 went out using the vehicle 80 in the past. For example, when the weather at the date and time at which the user is scheduled to go out is expected to be rainy, the confirmation unit 13 may surmise that the vehicle 80 is used at the date and time at which the user is scheduled to go out. For example, when the destination to which the user is scheduled to go falls within a middle distance category (for example, a distance of 3 km to 50 km) from an address of the user 91, the confirmation unit 13 may surmise that the vehicle 80 is used at the date and time at which the user is scheduled to go out.

When the confirmation unit 13 determines that the schedule information 22 is not sufficient to specify the date and time at which the user 91 is not scheduled to use the vehicle 80, the confirmation unit 13 may surmise the date and time at which the user 91 is not scheduled to use the vehicle 80 based on a past action history of the user 91. The confirmation unit 13 may notify the user 91 to confirm whether or not the surmised date and time is correct. For example, the confirmation unit 13 may surmise that the transportation means other than the vehicle 80 is used at the date and time of traveling to a destination registered in the schedule information 22 when the destination is the same as a destination indicating a place where the user 91 went out using transportation means other than the vehicle 80 in the past. For example, when the weather at the date and time at which the user is scheduled to go out is expected to be fine, the confirmation unit 13 may surmise that the transportation means other than the vehicle 80 (for example, walking) is used for the destination to which the user is scheduled to go. For example, when the destination to which the user is scheduled to go falls within a short distance category (for example, a distance of less than 3 km) from the address of the user 91, the confirmation unit 13 may surmise that the transportation means other than the vehicle 80 (for example, walking) is used at the date and time at which the user is scheduled to go out. For example, when the destination to which the user is scheduled to go falls within a ling distance category (for example, a distance of 50 km or more) from the address of the user 91, the confirmation unit 13 may surmise that the transportation means other than the vehicle 80 (for example, public transportation system such as a train or an airplane) is used at the date and time at which the user is scheduled to go out.

In order to confirm whether or not the surmised date and time is correct, the confirmation unit 13 may send, to the user 91, an email with a link to a web page for registering a response to an inquiry on whether or not the surmised date and time as correct, or have a conversation with the user 91 using voice recognition.

When the date and time of traveling is registered in the schedule information 22 but the transportation means to be used when traveling is not registered, the confirmation unit 13 may confirm the transportation means to the user 91. It is possible to specify whether the vehicle 80 is used or not as long as the transportation means to be used when traveling can be specified. Consequently, it is possible to specify whether the date and time of traveling is the date and time at which the user 91 is scheduled to use the vehicle 80, or alternatively, the date and time at which the user 91 is not scheduled to use the vehicle 80. In order to confirm the transportation means, the confirmation unit 13 may send, to the user 92, an e-mail with a link to a web page for registering a response to an inquiry of the transportation means, or have a conversation with the user 91 using voice recognition.

The first notification unit 14 notifies a parking space management system 30, which manages rental of the parking space 70 for a user 92 who desires to use the parking space 70, of information indicating the date and time at which the user 91 is scheduled to use the vehicle 80 as information indicating a vacant time at which the parking space 70 is available. For example, when the parking space 70 is used for parking space sharing, the parking space management system 30 is a computer system that manages affairs of the parking space sharing (for example, management such as an acceptance, a change, or a cancellation of a reservation for renting the parking space 70). The user 92 can access the parking space management system 30 from an information terminal 50 via a communication network and can perform an acceptance, a change, a cancellation, or the like of a reservation for renting the parking space 70.

A second notification unit 15 notifies a vehicle management system 40, which manages rental of the vehicle 80 for a user 93 who desires to use the vehicle 80, of information indicating the date and time at which the user 91 is not scheduled to use the vehicle 80 as information indicating a vacant time at which the vehicle 80 is available. For example, when the vehicle 80 is used for car sharing, the vehicle management system 40 is a computer system that manages affairs of the car sharing (for example, management such as acceptance, change, or cancellation of a reservation for renting the vehicle 80). The user 93 can access the vehicle management system 40 from an information terminal 60 via a communication network, and can perform acceptance, change, cancellation, the like of a reservation for renting the vehicle 80.

According to the embodiment of the present disclosure, it is possible to specify the date and time at which the user 91 is scheduled to use the vehicle 80 and the date and time at which the user 91 is not scheduled to use the vehicle 80 from the schedule information 22 indicating the action schedule of the user 91 having the authority to use the vehicle 80 and the parking space 70 together. The parking space management system 30 is notified of the information indicating the date and time at which the user 91 is scheduled to use the vehicle 80 as information indicating the vacant time at which the parking space 70 is available, and the vehicle management system 40 is notified of the information indicating the date and time at which the user 91 is not scheduled to use the vehicle 80 as information indicating the vacant time at which the vehicle 80 is available. Accordingly, it is possible to manage a rental schedule of the vehicle 80 and a rental schedule of the parking space 70 at a low cost in an integrated manner.

The vehicle 80 and the parking space 70 are exemplified as resources that can be used for sharing, among the resources that the user 91 has the authority to use, in the description stated above. However, the embodiment of the present disclosure is not limited thereto, and the resources as described above may be, for example, a bicycle, a bicycle parking space, leisure goods (for example, barbecue accessories), or in-office or household equipment.

The parking space management system 30 may have functions equivalent to the functions of the units (the acquisition unit 11, the specification unit 12, and the confirmation unit 13) to specify the date and time at which the user 91 is scheduled to use the vehicle 80 from the schedule information 22. Similarly, the vehicle management system 40 may have functions equivalent to the functions of the units (the acquisition unit 11, the specification unit 12, and the confirmation unit 13) to specify the date and time when the user 91 is not scheduled to use the vehicle 80 from the schedule information 22.

The embodiment described above is intended to facilitate understanding of the gist of the present disclosure and is not intended to limit an applicable embodiment of the present disclosure in any way. The present disclosure can be modified or improved without departing from the gist of the present disclosure and the present disclosure also encompasses equivalents of the present disclosure.

What is claimed is:

1. A management system comprising a processing device configured to acquire schedule information indicating an action schedule of is user having authority to use a vehicle and authority to use a parking space set to park the vehicle,
specify, from the schedule information, a date and time at which the user is scheduled to use the vehicle and a date and time at which the user is not scheduled to use the vehicle,
notify a parking space management system, which manages rental of the parking space for a user who desires to use the parking space, of information indicating the date and time at winch the user is scheduled to use the vehicle as information indicating a vacant time at which the parking space is available, and
notify a vehicle management system, which manages rental of the vehicle for a user who desires to use the vehicle, of information indicating the date and tine at which the user is not scheduled to use the vehicle as information indicating a vacant time at which the vehicle is available.

2. The management system according to claim 1, wherein:
the processing device is configured to surmise the date and time at which the user is scheduled to use the vehicle based on a past action history of the user when the processing device determines that the schedule information is not sufficient to specify the date and tune at which the user is scheduled to use the vehicle; and
the processing device is configured to notify the user to confirm whether or not the surmised date and time is correct.

3. The management system according to claim 1, wherein:
the processing device is configured to surmise a date and time at which the user is not scheduled to use the vehicle based on a past action history of the user when the processing device determines that the schedule information is not sufficient to specify the date and time at which the user is not scheduled to use the vehicle; and
the processing device is configured to notify the user to confirm whether or not the surmised date and time is correct.

4. The management system according to claim 2, wherein the processing device is configured to surmise that the vehicle is used at a date and time of traveling to a destination registered in the schedule information when the destination is the same as a destination indicating a place where the user went out using the vehicle in the past.

5. The management system according to claim 3, wherein the processing device is configured to surmise that transportation means other than the vehicle is used at a date and time of traveling to a destination registered in the schedule information when the destination is the same as a destination indicating a place where the user went out using the transportation means other than the vehicle in the past.

6. The management system according to claim 1, wherein the processing device is configured to notify the user to confirm transportation means when a date and time of traveling is registered in the schedule information but transportation means is not registered.

7. A management method comprising:
acquiring schedule information indicating an action schedule of a user having authority to use a vehicle and authority to use a parking space, set to park the vehicle, by a processing device;
specifying, from the schedule information, a date and time at which the user is scheduled to use the vehicle and a date and time at which the user is not scheduled to use the vehicle, by the processing device;
notifying a parking space management system, which manages rental of the parking space for a user who desires to use the parking space, of information indicating the date and time at which the user is scheduled to use the vehicle as information indicating a vacant time at which the parking space is available, by the processing, device; and
notifying a vehicle management system, which manages rental of the vehicle for a user who desires to use the vehicle, of information indicating the date and time at which the user is not scheduled to use the vehicle as information indicating a vacant time at which the vehicle is available, by the processing device.

8. A readable non-transitory recording medium in which a plurality of instructions is recorded, the instructions being executed by one or more processing devices to cause the one or more processing devices to perform a method comprising:
acquiring schedule information indicating an action schedule of a user having authority to use a vehicle and authority to use a parking space set to park the vehicle, by a processing device;
specifying, from the schedule information, a date and time at which the user is scheduled to use the vehicle and a date and time at which the user is not scheduled to use the vehicle, by the processing device;
notifying a parking space management system, which manages rental of the parking space for a user who desires to use the parking space, of information indicating the date and time at which the user is scheduled to use the vehicle as information indicating a vacant time at which the parking space is available, by the processing device; and
notifying a vehicle management system, which manages rental of the vehicle for a user who desires to use the vehicle, of information indicating the date and time at which the user is not scheduled to use the vehicle as information indicating a vacant time at which the vehicle is available, by the processing device.
